(19) United States
(12) Patent Application Publication
(10) Pub. No.: US 2007/0033240 A1
(43) Pub. Date: Feb. 8, 2007

(54) Scheduling garbage collection

(75) Inventors: Eric L. Barsness, Pine Island, MN (US); John M. Santosuosso, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/197,603

(22) Filed: Aug. 4, 2005

(51) Int. Cl. G06F 17/30

(52) U.S. Cl. 707/206

(57) ABSTRACT

Scheduling garbage collection by gathering garbage collection information about two or more garbage collection processes, and determining when at least one of the two or more garbage collection processes should execute in dependence upon the garbage collection information is disclosed. Garbage collection information may be gathered through inter-process communication between two or more garbage collection processes, or by gathering garbage collection information from a computer on which at least one garbage collection processes is running. Determining when at least one of garbage collection processes should execute in dependence upon the garbage collection information may include determining a time to execute at least one garbage collection process so as to reduce the likelihood that execution of two or more of the garbage collection processes will overlap. A master garbage collection scheduler may be provided to schedule garbage collection.

### BACKGROUND OF THE INVENTION

1. Field of the Invention

The field of the invention is data processing, or, more specifically, methods, apparatuses, and products for scheduling garbage collection.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Many conventional software applications run on virtual machines. A virtual machine is a self-contained operating environment that behaves in many ways as if it is a separate computer. Applications running within the virtual machines typically have little or no access to the operating system of the computer on which they are installed.

Virtual machines advantageously provide system independence because they are isolated from the underlying hardware and software of the system. Virtual machines also advantageously provide security because the applications running within these virtual machines have little or no contact with the operating system, and therefore there is reduced possibility of an application running one the virtual machine damaging other files or applications.

Because virtual machines are implemented for various computer platforms, an application written for the virtual machine can be operated on any platform for which a compatible virtual machine is available. Thus, the use of virtual machines allows one version of an application to be made that will operate on any computer and operating system for which a suitable virtual machine is available.

The Java Virtual Machine (‘JVM’) is a well-known example of a virtual machine. Each JVM implementation is implemented for a particular host operating system and/or hardware system. Java virtual machine is a virtual machine that runs Java bytecode. Java bytecode is typically generated by a Java programming language compiler, although Java bytecode may be generated by compilers for other programming languages as well. The Java bytecode is not compiled to execute on a particular hardware platform. Rather, particular implementations of the JVM are hardware platform specific. Each Java virtual machine, regardless of what hardware platform the Java virtual machine is implemented for, should execute the Java bytecode in a consistent manner.

Many conventional virtual machines provide for garbage collection. Collecting garbage or garbage collection is the process of identifying objects in a heap that are no longer needed, called garbage or garbage objects, and removing those objects from the heap. Typical garbage collection processes do not actually delete garbage objects, but instead typically the garbage collection processes identify that the memory occupied by the garbage objects is available to be overwritten by new objects that need to be added to the heap.

A garbage collection process typically executes to collect garbage at a time and in a manner that depends on the specifics of the virtual machine that the garbage collection process serves. Some garbage collection processes collect garbage when the heap reaches a certain capacity. In certain implementations, the heap is sub-divided into regions that are garbage collected at different frequencies. Additionally, garbage collection processes may collect garbage in more than one manner.

A garbage collection process executes to collect garbage at a time and in a manner that depends on the specifics of the virtual machine that the garbage collection process serves. That is, a garbage collection process collects garbage from the heap, as determined by the specifics of the implementation of virtual machine, such as, for example, when the garbage collection's heap reaches a certain capacity. In certain implementations, heaps may be sub-divided into regions that are garbage collected at different frequencies.

Garbage collection by even a single virtual machine can degrade the computer's performance because garbage collection processes tend to require accessing many objects stored memory and tracing references to and from those objects. Garbage collection can be particularly resource intensive when many of the accessed objects reside in virtual memory. If more than one virtual machine is in use, and as a result, more than one garbage collection process is executing at a given time, computer system performance may be significantly degraded.

### SUMMARY OF THE INVENTION

Exemplary methods, apparatuses, and products are described for scheduling garbage collection by gathering garbage collection information about two or more garbage collection processes, and determining when at least one of the two or more garbage collection processes should execute in dependence upon the garbage collection information. Garbage collection information may be gathered by communicating garbage collection information through inter-process communication between two or more garbage collection processes. The garbage collection information may include, for example, an anticipated garbage collection time for at least one of the garbage collection processes. In certain embodiments, gathering garbage collection information may include gathering garbage collection information from a computer on which at least one of the two or more garbage collection processes is running. In such embodiments, the garbage collection information may include computer resource utilization information.

Determining when at least one of garbage collection processes should execute in dependence upon the garbage collection information may include determining a time to execute at least one garbage collection process so as to reduce the likelihood that execution of two or more of the garbage collection processes will overlap.

In an embodiment, a master garbage collection scheduler may be provided. A master garbage collection scheduler gathers the garbage collection information. The master garbage collection scheduler sends a garbage collection instruction in dependence upon the garbage collection information. The garbage collection instruction may include, for example, an execution time for at least one garbage collection process. At least one of the garbage collection processes may receive the garbage collection instruction from the master garbage collection scheduler. In certain embodiments, one of the two or more garbage collection processes is the master garbage collection scheduler.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating an exemplary system for scheduling garbage collection according to embodiments of the present invention.

FIG. 2 sets forth a block diagram of automated computing machinery useful for scheduling garbage collection according to embodiments of the present invention.

FIG. 3 sets forth a flow chart illustrating an exemplary method for scheduling garbage collection according to embodiments of the present invention.

FIG. 4 sets forth an additional flow chart illustrating an exemplary method for scheduling garbage collection according to embodiments of the present invention.

FIG. 5 sets forth an additional flow chart illustrating an exemplary method for scheduling garbage collection according to embodiments of the present invention.

### DETAILED DESCRIPTION OF EXEMPLARY EMBODIMENTS

### Scheduling Garbage Collection

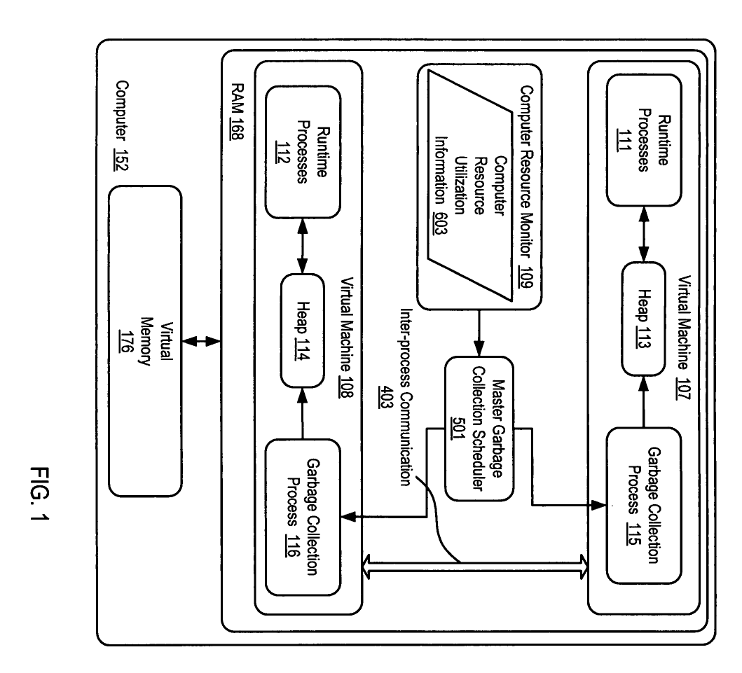

Exemplary methods, apparatuses, and products for scheduling garbage collection according to embodiments of the present invention are described with reference to the accompanying drawings, beginning with FIG. 1. FIG. 1 sets forth a block diagram illustrating an exemplary system for scheduling garbage collection according to embodiments of the present invention. The system of FIG. 1 operates generally to schedule garbage collection according to embodiments of the present invention by gathering garbage collection information about two or more garbage collection processes and determining when at least one of the two or more garbage collection processes should execute in dependence upon the garbage collection information.

The system of FIG. 1 includes a computer (152) having two or more virtual machines (107, 108) in random access memory RAM (168). As discussed above, a virtual machine is a self-contained operating environment that behaves in many ways as if it is a separate computer. Each virtual machine (107, 108) stored in RAM (168) includes one or more runtime processes (111, 112), computer program instructions for implementing one or more functions of an application being executed by the virtual machine (107, 108). For purposes of this description, runtime processes (111, 112) include all of the features of the virtual machines (107, 108) except garbage collection processes (115, 116) and heaps (113, 114). For example, runtime processes (111, 112) may include, but are not limited to just-in-time compilers, interpreters, class loaders, monitor pools, constant pools and other runtime processes that will occur to those of skill in the art.

Each virtual machine also includes a heap (113, 114). A heap (113, 114) is an area of memory allocated for use by a virtual machine (107, 108). A virtual machine (107, 108) uses a heap (113, 114) to store objects used by the virtual machine (107, 108) to execute program instruction. Heaps (113, 114) may include memory allocated from RAM (168) and virtual memory (176). That is, an object used by virtual machines (107, 108) maybe stored in RAM (168) or in virtual memory (176).

The exemplary a virtual machine (107, 108) of FIG. 1 also includes a garbage collection process (115, 116), computer program instructions for collecting garbage. Collecting garbage or garbage collection is the process of identifying objects in a heap that are no longer needed, called garbage or garbage objects, and removing those objects from the heap. Typical garbage collection processes do not actually delete garbage objects, but instead typically the garbage collection processes identify that the memory occupied by the garbage objects is available to be overwritten by new objects that need to be added to the heap.

The example of FIG. 1 includes a master garbage collection scheduler (501) stored in RAM (168). Master garbage collection scheduler (501) is a set of computer program instructions for scheduling garbage collection according to embodiments of the present invention. The exemplary master garbage collection scheduler (501) schedules garbage collection in dependence upon garbage collection information (not shown in FIG. 1) by gathering garbage collection information about two or more garbage collection processes and determining when at least one of the two or more garbage collection processes should execute in dependence upon the garbage collection information. Master garbage collection scheduler (501) advantageously schedules garbage collection to reduce the likelihood that execution of two or more of the garbage collection processes will overlap.

‘Garbage collection information’ refers to information relevant to scheduling a garbage collection process. For example, garbage collection information may include, but is not limited to, information directly related to one or more garbage collection processes. Examples of information directly related to one or more garbage collection processes includes whether one or more garbage collection process of a virtual machine are currently running, anticipated execution times of a garbage collection processes, how long a garbage collection process is expected to take, or how long a garbage collection process can be delayed. Garbage collection information may also include information about the utilization of computer system resources. Information about the utilization of computer system resources may include, but is not limited to, paging rates, processor usage, number of processes, number of threads, page faults, and so forth.

Master garbage collection scheduler (501) may gather garbage collection information from garbage collection processes (115, 116), or from a computer resource monitor (109). Computer resource monitor (109) is a set of computer program instructions for monitor computer resource utilization information (603).

In one embodiment, upon determining when at least one of the two or more garbage collection processes should execute in dependence upon the garbage collection information, master garbage collection scheduler (501) issues a garbage collection instruction to one or more garbage collection processes indicating a time when the garbage collection process should collect garbage. A garbage collection instruction typically includes a time when the garbage collection process should collect garbage. The garbage collection instruction may be a command to execute garbage collection that the garbage collection process must follow. Alternately, the garbage collection instruction may be a recommended time for the garbage collection process to collect garbage which the garbage collection process may ignore if the virtual machine the garbage collection process serves requires garbage collection at a different time.

The garbage collection instruction may be a command that the garbage collection process must follow. Alternately, the garbage collection instruction may be a recommended time for the garbage collection process to collect garbage which the garbage collection process may not follow if the virtual machine the garbage collection process serves requires garbage collection at a different time.

In alternate embodiments of the present invention, one of the virtual machines (107, 108) may act as the master garbage collection scheduler (501). That is, in alternate embodiments no stand alone master garbage collector exists. Instead, one of the virtual machines is configured so that a runtime process or garbage collection process schedules garbage collection for one or more other garbage collection processes as well as its own garbage collection.

In certain other embodiments, no master garbage collection scheduling functions exist at all. In such embodiments, each garbage collection process (115, 116) may schedule its own garbage collection based upon garbage collection information received from other garbage collection processes. The garbage collection processes (115, 116) may communicate via inter-process communication (403) to coordinate scheduling of garbage collection.

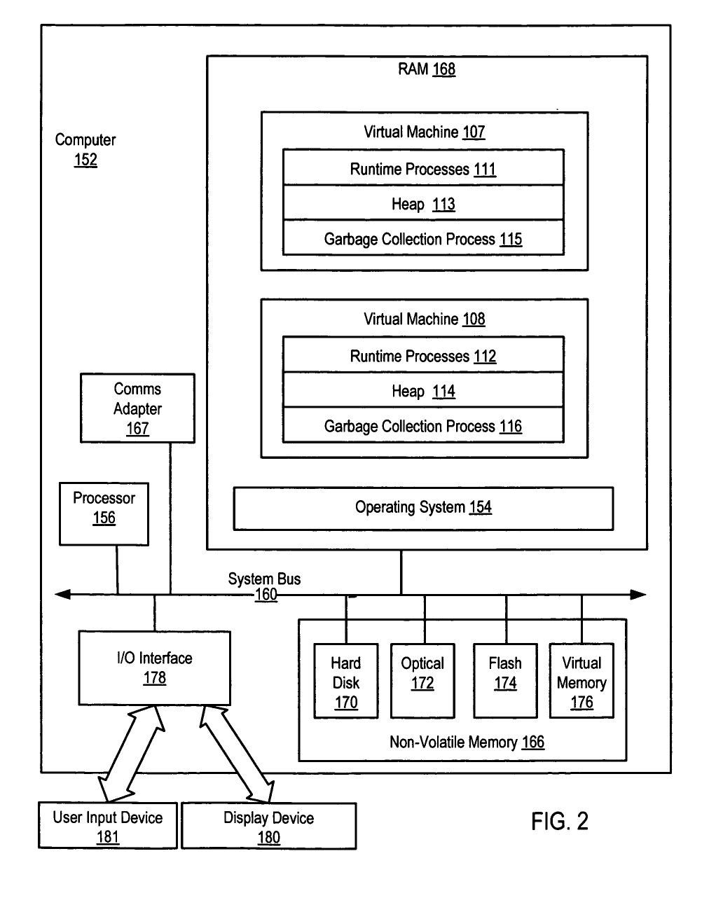

As mentioned above, scheduling garbage collection in accordance with the present invention is generally implemented with computers, that is, with automated computing machinery. For further explanation, FIG. 2 sets forth a block diagram of automated computing machinery comprising an exemplary computer (152) useful for scheduling garbage collection according to embodiments of the present invention. In addition to the system elements that were described above with respect to FIG. 1, the system of FIG. 2 includes some elements not discussed with regard to FIG. 1, and some of the elements shown in FIG. 1 are described further with regard to FIG. 2. The computer (152) of FIG. 2 includes at least one computer processor (156) or ‘CPU’ as well as random access memory (168) (“RAM”) which is connected through a system bus (160) to processor (156) and to other components of the computer.

Stored in RAM (168) are two virtual machines. Each virtual machine stored RAM (168) includes one or more runtime processes (111,112), a heap (113, 114), and a garbage collection process (115, 116). Also stored in RAM (168) is a set of computer program instructions (not shown in FIG. 2) for scheduling garbage collection according to embodiments of the present invention. The computer program instructions for scheduling garbage collection operate generally by gathering garbage collection information about two or more garbage collection processes (115, 116), and determining when at least one of the two or more garbage collection processes (115, 116) should execute in dependence upon the garbage collection information.

The example of FIG. 2 includes two garbage collection processes. This is for explanation and not for limitation. In fact, scheduling garbage collection according to embodiments of the present invention may be used to schedule any number of garbage collection process as will occur to those of skill in the art.

Also stored in RAM (168) is an operating system (154). Operating systems useful in computers according to embodiments of the present invention include UNIX™, Linux™, Microsoft Windows NT™, IBM AIX™, IBM i5/OS™, and others as will occur to those of skill in the art. Operating system (154), and virtual machines (107, 108) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art. A portion of non-volatile memory (166) may be designated as virtual memory (176). Virtual memory (176) may supplement RAM (168) by certain storing software components or data to free up space in RAM (168).

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications with other computers. Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and adapters for wireless network communications.

It will be appreciated that computer system (152) can be a standard personal computer or workstation, minicomputer, mainframe, palmtop, or any other suitable computing device, and will typically include many other components (not shown) that are not directly relevant to an understanding of the present invention. Note that computer (152) may also be an embedded system, such as a set top box, or any other hardware device including a processor (156) and software (107, 108, 154).

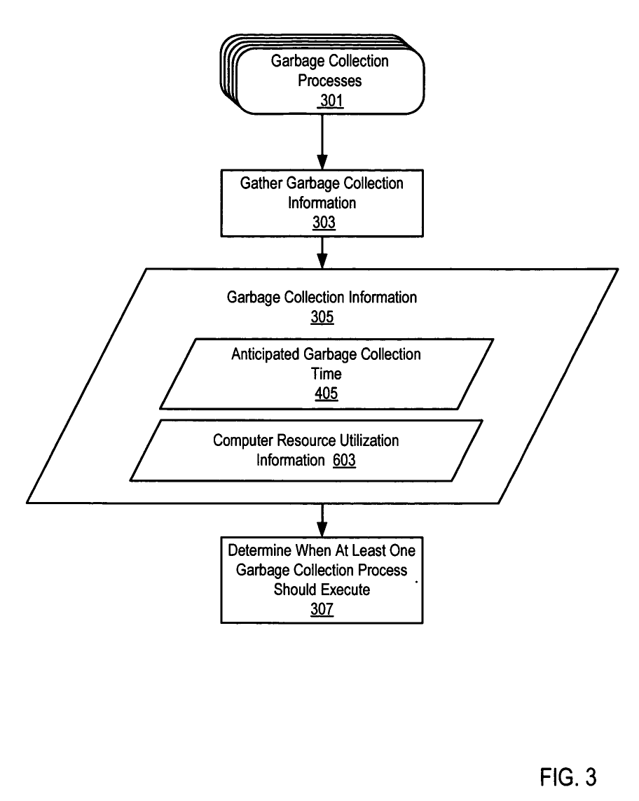

For further explanation, FIG. 3 sets forth a flow chart illustrating an exemplary method for scheduling garbage collection according to embodiments of the present invention. The method of FIG. 3 includes gathering (303) garbage collection information (305) about two or more garbage collection processes (301). As discussed above, ‘garbage collection information’ refers to information that may be relevant to scheduling a garbage collection process. For example, garbage collection information may include, but is not limited to, information directly related to one or more garbage collection processes. Examples of information directly related to one or more garbage collection processes includes whether one or more garbage collection processes of one or more virtual machines are currently running, anticipated execution times of a garbage collection processes, how long a garbage collection process is expected to take, or how long a garbage collection process can be delayed. Garbage collection information may also include information about the utilization of computer system resources. Information about the utilization of computer system resources may include, but is not limited to, paging rates, processor usage, number of processes, number of threads, page faults, and so forth.

Gathering (303) garbage collection information (305) about two or more garbage collection processes (301) according to the method of FIG. 3 may be carried out by, for example, requesting from one or more garbage collection processes garbage collection information and receiving in response to the request the garbage collection information. Gathering (303) garbage collection information (305) about two or more garbage collection processes (301) according to the method of FIG. 3 may be carried out by receiving garbage collection information from one or more garbage collection process that are configured to send garbage collection information at some regular interval or based on certain parameters, such as an approaching need to collect garbage.

Gathering (303) garbage collection information (305) about two or more garbage collection processes (301) according to the method of FIG. 3 may also be carried out by monitoring computer system resource utilization. Computer resource utilization information is information about how computer resources are being used. Examples of computer resource utilization information include, but are not limited to, paging rates, processor utilization rates, etc. Computer resource utilization information provides an indication of whether processes running on a computer are utilizing resource to such an extent that computer system performance may be degraded. For example, high paging rates may indicate that one or more garbage collection processes are running. If the paging rates become too high computer system performance may be degraded. Therefore, if the computer resource utilization information indicates that paging rates are high, one or more garbage collection processes may delay garbage collection in an attempt to avoid degrading computer system performance.

The method of FIG. 3 also includes determining (307) when at least one of the two or more garbage collection processes (301) should execute in dependence upon the garbage collection information (305). Determining (307) when at least one of the two or more garbage collection processes (301) should execute in dependence upon the garbage collection information (305) according to the method of FIG. 3 may be carried out by identifying a time for more garbage collection processes to execute such that each garbage collection process may collect garbage to meet the garbage collection needs of the virtual machine served by the garbage collection process and preferably, with minimal impact on computer system performance.

In the example of FIG. 3, the garbage collection information (305) includes an anticipated garbage collection time (405) for a garbage collection process and computer resource utilization information (603) of the computer on which the garbage collection process that created the garbage collection information is running. The inclusion of an anticipated garbage collection time (405) for a garbage collection process and computer resource utilization information (603) in the garbage collection information is for explanation and not for limitation. In fact, garbage collection information may include information useful in determining when at least one of the two or more garbage collection processes should execute such as whether one or more garbage collection processes of one or more virtual machines are currently running, how long a garbage collection process is expected to take, how long a garbage collection process can be delayed and any other information that will occur to those of skill in the art.

Determining (307) when at least one of the two or more garbage collection processes (301) should execute in dependence upon the garbage collection information (305) according to the method of FIG. 3 may be carried out by a master garbage collection scheduler that prioritizes the garbage collection processes and directs the garbage collection processes to execute according to the prioritization. The master garbage collection scheduler typically schedules the garbage collection processes to avoid more that one garbage collection process executing at any time.

In embodiments without a master garbage collection scheduler, determining (307) when at least one of the two or more garbage collection processes (301) should execute in dependence upon the garbage collection information (305) according to the method of FIG. 3 may be carried out by identifying the garbage collection needs of the virtual machine the garbage collection process is serving and determining a time for execution in dependence upon the garbage collection information to meet the needs of the virtual machine it serves and to avoid executing concurrently with other garbage collection processes. One way of determining a time for execution in dependence upon the garbage collection information to meet the needs of the virtual machine it serves and to avoid executing concurrently with other garbage collection processes may be carried out by receiving anticipated garbage collection time from other garbage collection processes based on the needs of the other virtual machines. Upon receiving an anticipated garbage collection time from another garbage collection process, a garbage collection process may determine a time for collecting garbage that avoids collecting garbage concurrently with other garbage collection processes.

Determining (307) when at least one of the two or more garbage collection processes (301) should execute in dependence upon the garbage collection information (305) according to the method of FIG. 3 may be carried out by identifying high computer resource utilization rates, such as high paging rates, which may indicate that another garbage collection process are executing. If a garbage collection process is approaching a need to collect garbage, but detects high computer resource utilization rates, such a garbage collection process may delay its own garbage collection to attempt to allow the computer resource utilization rates to decrease before collecting garbage.

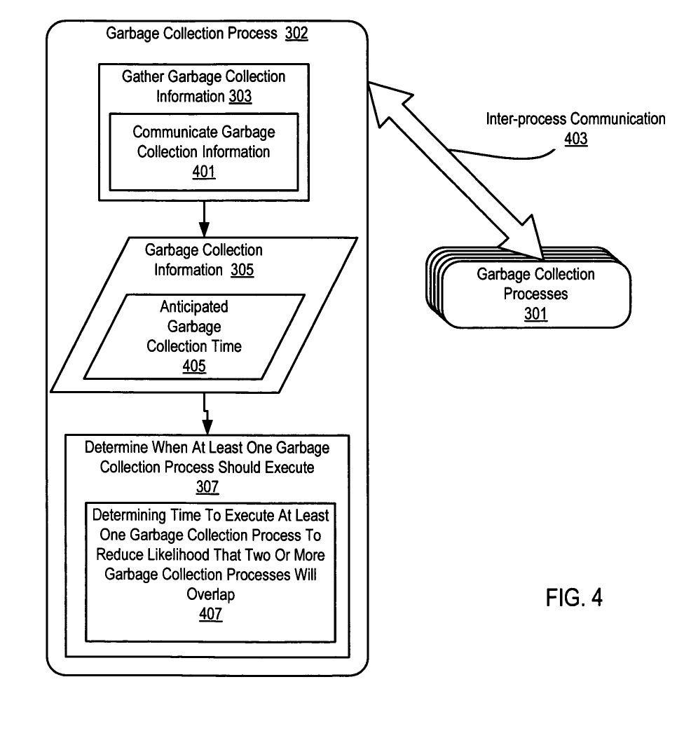

For further explanation, FIG. 4 sets forth a flow chart illustrating another exemplary method for scheduling garbage collection according to embodiments of the present invention. In the method of FIG. 4, gathering (303) garbage collection information (305) is carried out by communicating (401) garbage collection information through inter-process communication (403) between two or more garbage collection processes (301, 302). Communicating garbage collection information includes a first garbage collection process sending garbage collection information and a second garbage collection process receiving the garbage collection information. The garbage collection processes (301, 302) may be configured to communicate (401) garbage collection information (303) to one other, that is, to send and receive garbage collection information periodically or in response to a request for garbage collection information.

Having gathered garbage collection information, each of the two or more garbage collection processes may schedule its own garbage collection based on the gathered garbage collection information. That is, a first garbage collection process (302) may receive garbage collection information (305) from at least one other garbage collection process (301). The first garbage collection process (302) may then schedule its garbage collection based at least in part on the garbage collection information received from at least one second garbage collection process (301).

In the method of FIG. 4, garbage collection information (305) includes an anticipated garbage collection time (405) for at least one of the two or more garbage collection processes (301, 302). An anticipated garbage collection time (405) is an initial estimate of the time that the garbage collection process creating the garbage collection information will execute. The anticipated garbage collection time is an estimate because when the garbage collection process actual executes is dependent upon the virtual machine it is serving and the runtime processes being executed by the virtual machine. If the runtime processes fill the heap faster than expected by the garbage collection process, garbage collection may be executed sooner than the anticipated garbage collection time. Likewise, if the runtime processes fill the heap slower than expected by the garbage collection process, garbage collection may be executed later than the anticipated garbage collection time.

The anticipated garbage collection time may also include an expected duration of a garbage collection process. The anticipated garbage collection time and duration are determined based on the specific configuration of the garbage collection process to which they pertain. For example, the expected duration of the garbage collection process may depend on how often the garbage collection process runs, whether the heap is sub-divided into portions that are garbage collected at different frequencies, and/or how the garbage collection process identifies garbage objects.

In the method of FIG. 4, determining (307) when at least one of the two or more garbage collection processes (301, 302) should execute in dependence upon the garbage collection information (305) also includes determining (407) a time to execute at least one of the two or more garbage collection processes (301, 302) so as to reduce the likelihood that execution of two or more of the garbage collection processes (301, 302) will overlap. If the execution of two or more of the garbage collection processes overlaps, the performance of the computer system may be degraded. Scheduling garbage collection so that execution of garbage collection processes does not overlap may reduce the effect of garbage collection on computer system performance.

Determining (407) a time to execute at least one of the two or more garbage collection processes (301, 302) so as to reduce the likelihood that execution of two or more of the garbage collection processes (301, 302) will overlap according to the method of FIG. 4 may include identifying the anticipated garbage collection time of another garbage collection process and the anticipated duration of garbage collection of another garbage collection process, Determining (407) a time to execute may also include anticipating in dependence upon the anticipated garbage collection time and the anticipated duration a time that the other garbage collection process will be finished collecting garbage and selecting the time for garbage collection.

Determining (407) a time to execute at least one of the two or more garbage collection processes (301, 302) so as to reduce the likelihood that execution of two or more of the garbage collection processes (301, 302) will overlap according to the method of FIG. 4 may also include identifying the anticipated garbage collection time of another garbage collection process and selecting a time for garbage collection prior to the anticipated garbage collection time of the other garbage collection process. Selecting a time for garbage collection prior to the anticipated garbage collection time of the other garbage collection process typically includes selecting a time for garbage collection that allows the garbage collection process to complete collecting garbage before the anticipated garbage collection time of the other garbage collection process.

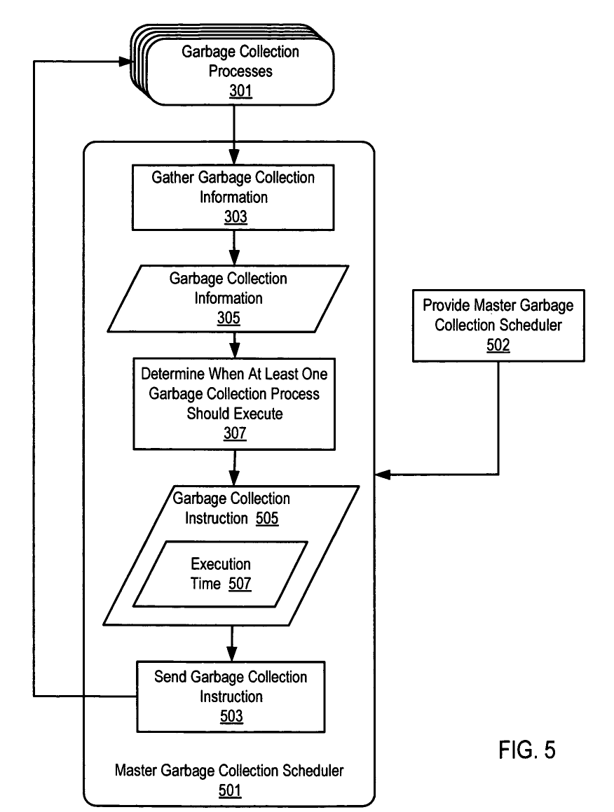

For further explanation, FIG. 5 sets forth an additional flow chart illustrating another exemplary method for scheduling garbage collection according to embodiments of the present invention. The method of FIG. 5 includes providing (502) a master garbage collection scheduler (501). A ‘master garbage collection scheduler’ is a system, apparatus, or process which schedules garbage collection for one or more garbage collection processes. In the example of FIG. 5 a master garbage collection scheduler (501) gathers (301) garbage collection information about two or more garbage collection processes and determines (307) when at least one of the two or more garbage collection processes should execute in dependence upon the garbage collection information.

The method of FIG. 5 also includes send (503) to one or more garbage collection process a garbage collection instruction (505). As discussed above, a garbage collection instruction typically indicates a time when the garbage collection process should collect garbage. The garbage collection instruction may be a command to execute garbage collection that the garbage collection process must follow.

Alternately, the garbage collection instruction may be a recommended time for the garbage collection process to collect garbage which the garbage collection process may ignore if the virtual machine the garbage collection process serves requires garbage collection at a different time.

In the example of FIG. 5, the garbage collection instruction (505) includes an execution time (507) for at least one of the two or more garbage collection processes (301). An execution time is typically determined so as to avoid having more than one garbage collection process collecting garbage at any time. The garbage collection instruction (505) may be implemented as a command to at least one of the two or more garbage collection processes (301). Such a command may cause at least one garbage collection process to execute at the execution time (507) indicated by the garbage collection instruction (505). However, in some embodiments, the garbage collection instruction (505) may be implemented to communicate a recommended garbage collection time for one or more of the garbage collection processes. That is, a garbage collection process receiving the garbage collection instruction (505) may execute according a number of parameters based on the garbage collection process's configuration. The execution time (507) included in garbage collection instruction (505) may be only one of a number of parameters considered by the garbage collection processes in determining when to execute. Such an embodiment may allow each garbage collection process to continue to serve the needs of its own virtual machine while also attempting to avoid overlapping garbage collecting with other garbage collection processes.

Exemplary embodiments of the present invention are described largely in the context of a fully functional computer system for scheduling garbage collection. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for scheduling garbage collection, the method comprising:
gathering garbage collection information about two or more garbage collection processes; and
determining when at least one of the two or more garbage collection processes should execute in dependence upon the garbage collection information.

2. The method of claim 1 wherein gathering garbage collection information comprises communicating garbage collection information through inter-process communication between two or more garbage collection processes, the garbage collection information comprising:
an anticipated garbage collection time for at least one of the two or more garbage collection processes.

3. The method of claim 1 wherein determining when at least one of the two or more garbage collection processes should execute in dependence upon the garbage collection information comprises determining a time to execute at least one of the two or more garbage collection processes so as to reduce the likelihood that execution of two or more of the garbage collection processes will overlap.

4. The method of claim 1 further comprising:
providing a master garbage collection scheduler; wherein the master garbage collection scheduler gathers the garbage collection information; and
receiving from the master garbage collection scheduler a garbage collection instruction.

5. The method of claim 4 wherein one of the two or more garbage collection processes is the master garbage collection scheduler.

6. The method of claim 4 wherein the garbage collection instruction comprises an execution time for at least one of the two or more garbage collection processes.

7. The method of claim 1 wherein garbage collection information comprises computer resource utilization information.

8. An apparatus for scheduling garbage collection, the apparatus comprising at least one computer processor, at least one computer memory operatively coupled to the computer processor, and computer program instructions disposed within the computer memory capable of:
gathering garbage collection information about two or more garbage collection processes; and
determining when at least one of the two or more garbage collection processes should execute in dependence upon the garbage collection information.

9. The apparatus of claim 8 further comprising computer program instructions disposed within the computer memory capable of communicating garbage collection information through inter-process communication between two or more garbage collection processes, the garbage collection information comprising:
an anticipated garbage collection time for at least one of the two or more garbage collection processes.

10. The apparatus of claim 8 further comprising further comprising computer program instructions disposed within the computer memory capable of:
providing a master garbage collection scheduler; wherein the master garbage collection scheduler gathers the garbage collection information; and
receiving from the master garbage collection scheduler a garbage collection instruction.

11. The apparatus of claim 10 wherein the garbage collection instruction comprises an execution time for at least one of the two or more garbage collection processes.

12. The apparatus of claim 8 wherein garbage collection information comprises computer resource utilization information.

13. A computer program product for scheduling garbage collection, the computer program product disposed upon a signal bearing medium, the computer program product comprising:
computer program instruction for gathering garbage collection information about two or more garbage collection processes; and
computer program instruction for determining when at least one of the two or more garbage collection processes should execute in dependence upon the garbage collection information.

14. The computer program product of claim 13 wherein the signal bearing medium comprises a recordable medium.

15. The computer program product of claim 13 wherein the signal bearing medium comprises a transmission medium.

16. The computer program product of claim 13 wherein computer program instruction for gathering garbage collection information comprises computer program instruction for communicating garbage collection information through inter-process communication between two or more garbage collection processes, the garbage collection information comprising:
an anticipated garbage collection time for at least one of the two or more garbage collection processes.

17. The computer program product of claim 13 wherein computer program instruction for determining when at least one of the two or more garbage collection processes should execute in dependence upon the garbage collection information comprises computer program instruction for determining a time to execute at least one of the two or more garbage collection processes so as to reduce the likelihood that execution of two or more of the garbage collection processes will overlap.

18. The computer program product of claim 13 further comprising:
computer program instruction for providing a master garbage collection scheduler; wherein the master garbage collection scheduler gathers the garbage collection information; and
computer program instruction for receiving from the master garbage collection scheduler a garbage collection instruction.

19. The computer program product of claim 18 wherein the garbage collection instruction comprises an execution time for at least one of the two or more garbage collection processes.

20. The computer program product of claim 13 wherein garbage collection information comprises computer resource utilization information.
